(19) United States
(12) Patent Application Publication
(10) Pub. No.: US 2016/0079646 A1
(43) Pub. Date: Mar. 17, 2016

(54) SIGNAL TRANSMISSION FLAT CABLE

(71) Applicants: SHONAN GOSEI-JUSHI SEISAKUSHO K.K., Hiratsuka-shi, Kanagawa (JP); TECHNO CORE CO., LTD., Taito-ku, Tokyo (JP)

(72) Inventor: Toshiaki ICHIGE, Hitachi-shi, Ibaraki (JP)

(21) Appl. No.: 14/786,448

(22) PCT Filed: Mar. 26, 2014
(86) PCT No.: PCT/JP2014/058517

§ 371 Date: Oct. 22, 2015

(30) Foreign Application Priority Data
Apr. 24, 2013 (JP) 2013-090853
Sep. 19, 2013 (JP) 2013-193655

(51) Int. Cl. H01P 3/02; H01B 7/08

(52) U.S. Cl. CPC H01P 3/026; H01B 7/0861

(57) ABSTRACT

A signal transmission flat cable is provided with an upper electrically insulating thin-film layer (4) and a lower electrically insulating thin-film layer (5) that cover a signal conductor (1), ground conductors (2, 2′), and an electrically insulating substrate (3) from above and below in the cable-thickness direction. A protective shielding layer (8) comprised of a metallic layer (6) and an electrically insulating plastic layer (7) surrounds the upper and lower electrically insulating thin-film layers so that the metallic layer is located inside and the electrically insulating plastic layer is located outside. The protective shielding layer surrounds the outer periphery of the upper and lower electrically insulating thin-film layers such that one end edge (10) and the other end edge (11) abut against each other in the cable-length direction. An abutting part (12) formed by abutting the two end edges of the protective shielding layer is located above the ground conductor (2).

### TECHNICAL FIELD

The present invention relates to a signal transmission flat cable that is thin and that has exceptional electrical characteristics, and in particular relates to a signal transmission flat cable that is suitable for use in the internal wiring of cellular telephones, notebook computers, and the like.

### BACKGROUND ART

In signal transmission flat cables to be used in high-density-wiring electronic devices such as cellular telephones and notebook computers, it is necessary for the flat cable to be thin in order to enable wiring to be arranged in a narrow space, and to have low loss of transmission in high-frequency bandwidths.

A coaxial cable was proposed as such a signal transmission flat cable (Patent Document 1). The coaxial cable comprises a signal conductor comprised of a metallic thin film; a ground conductor that is comprised of a metallic thin film and arranged on both sides in the cable-width direction of the signal conductor; an electrically insulating substrate on which the signal conductor and the ground conductor are layered; an upper electrically insulating thin-film layer and a lower electrically insulating thin-film layer that cover the signal conductor, the ground conductor, and the electrically insulating substrate from above and below in the cable-thickness direction; and a protective shielding layer with a metallic layer on one surface of which an electrically insulating plastic layer is layered, the protective shielding layer being provided directly to the outer periphery of the upper electrically insulating thin-film layer and the lower electrically insulating thin-film layer so that the electrically insulating plastic layer is located outside.

In the coaxial cable described above, the protective shielding layer surrounds the upper electrically insulating thin-film layer and the lower electrically insulating thin-film layer in a vertical cross-section of the cable, and has an overlapping part formed by overlapping one end edge thereof with the outside of the other end edge along the cable-length direction.

Multi-core coaxial cables have been also proposed in which a plurality of signal conductors are provided (Patent Document 2). For example, a central conductor in which signals are transmitted is sandwiched between insulating films, which are further covered by an external conductor to provide a cable having a square coaxial structure. A plurality of such cables are bundled in parallel for improvement in high-speed transmission and noise tolerance characteristics

### PRIOR ART DOCUMENTS

### Patent Documents

Patent Document 1: Japanese Patent Laid-open Publication No. 2011-119198

Patent Document 2: Japanese Patent Laid-open Publication No. 2003-323824

### SUMMARY OF INVENTION

### Problems to be Solved

In the signal transmission flat cable as disclosed in Patent Document 1, the protective shielding layer surrounds the upper electrically insulating thin-film layer and the lower electrically insulating thin-film layer in a vertical cross-section of the cable, and has an overlapping part formed by overlapping one end edge thereof with the outside of the other end edge along the cable-length direction. The upper electrically insulating thin-film layer and the lower electrically insulating thin-film layer are fused and integrally bonded with the metallic layer, thereby preventing deformation of the cable.

However, the overlapping part in the signal transmission flat cable is formed in a central part in the cable-width direction. When pressure is applied to the cable in the vertical direction with the upper electrically insulating thin-film layer and the lower electrically insulating thin-film layer being surrounded by the protective shielding layer, the upper electrically insulating thin-film layer and the lower electrically insulating thin-film layer could sag due to the thickness of the overlapping part, and the central part could become thinner than other portions. The electric field strength is greatest in the central portion in the cable-width direction in which the signal conductor is disposed. When the upper electrically insulating thin-film layer and the lower electrically insulating thin-film layer varies in thickness in the central portion, the signal transmission characteristics in high-frequency bandwidths are adversely affected.

Even in a multi-core coaxial cable in which a plurality of signal conductors are provided, the same disadvantages are presented in terms of preventing deformation of the cable and preventing the signal transmission characteristics in high-frequency bandwidths from being adversely affected.

It is therefore an object of the present invention to provide a signal transmission flat cable being capable of preventing deformation of the cable and suppressing any reduction in the signal transmission characteristics in high-frequency bandwidths.

### Means for Solving the Problems

The present invention that achieves the above-mentioned purpose comprises:

one or more signal conductors comprised of a metallic thin film that extend on a plane in parallel to one another in the cable-length direction;

a plurality of ground conductors comprised of a metallic thin film that are arranged on both sides in the cable-width direction of the signal conductors;

an electrically insulating substrate on which the signal conductors and the ground conductors are layered;

an upper electrically insulating thin-film layer and a lower electrically insulating thin-film layer that cover the signal conductors, the ground conductors, and the electrically insulating substrate from above and below in the cable-thickness direction; and

a protective shielding layer comprised of a metallic layer and an electrically insulating plastic layer to surround the outer periphery of the upper and lower electrically insulating thin-film layers such that the metallic layer is located inside and the electrically insulating plastic layer is located outside;

wherein the protective shielding layer surrounds the outer periphery with one end edge and the other end edge thereof abutting against each other along the cable-length direction, and the abutting part formed by abutting both the end edges of the protective shielding layer is located above the ground conductor.

### Effect of the Invention

In such a configuration, the protective shielding layer surrounds the outer periphery of the upper and lower electrically insulating thin-film layers with one end edge and the other end edge thereof abutting against each other along the cable-length direction. This allows deformation of the cable to be prevented. Furthermore, the abutting part formed by abutting both the end edges of the protective shielding layer is located above the ground conductor, so that any reduction in the signal transmission characteristics in high-frequency bandwidths can be suppressed.

The abutting part is preferably located above an area between an end part of a ground conductor on the side opposite the signal conductors and the central part in the cable-width direction of the ground conductor.

### BRIEF DESCRIPTION OF DRAWINGS

FIG. 1 is a perspective view with a vertical cross-sectional view in part, showing one embodiment of the signal transmission flat cable according to the present invention;

FIG. 2 is a vertical cross-sectional view illustrating a method for manufacturing the signal transmission flat cable of the embodiment shown in FIG. 1;

FIG. 3 is a perspective view with a vertical cross-sectional view in part, showing another embodiment of the signal transmission flat cable according to the present invention;

FIG. 4 is a vertical cross-sectional view illustrating a method for manufacturing the signal transmission flat cable shown in FIG. 3;

FIG. 5a is a vertical cross-sectional view illustrating a step for removing air in voids between a signal conductor and a ground conductor; and

FIG. 5b is a vertical cross-sectional view illustrating a step for removing air in voids between a signal conductor and a ground conductor.

### MODE OF CARRYING OUT THE INVENTION

The present invention will be described in detail below on the basis of the embodiments shown in the drawings.

### Embodiment 1

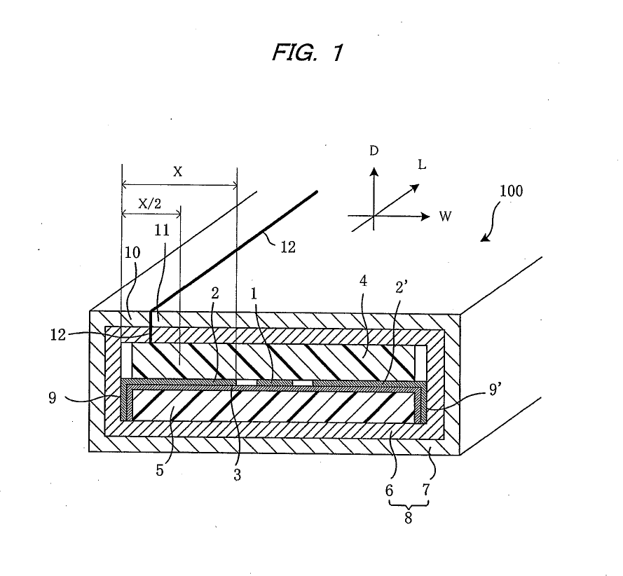

FIG. 1 is a perspective view in a vertical cross-section of a signal transmission flat cable 100, showing one embodiment of the present invention. A signal conductor 1 comprised of a metallic thin film and ground conductors 2, 2′ comprised of a metallic thin film are arranged on one surface of an electrically insulating substrate 3. The ground conductors 2, 2′ are arranged on both sides in the cable-width direction of the signal conductor 1 with the respective conductors being equal in length in the cable-width direction. In the present specification, the cable-width direction refers to the direction orthogonal to the cable-length direction indicated by L in FIG. 1 in which the signal transmission flat cable 100 extends. The cable-width direction is indicated by W in FIG. 1, extending leftward and rightward. The cable-thickness direction, indicated by D in FIG. 1, refers to the direction that is orthogonal to L and W and extends vertically.

An upper electrically insulating thin-film layer 4 and a lower electrically insulating thin-film layer 5 are provided so as to cover the signal conductor 1, the ground conductors 2, 2′, and the electrically insulating substrate 3 from above and below in the cable-thickness direction. A protective shielding layer 8, in which an electrically insulating plastic layer 7 is disposed on one surface of a metallic layer 6, is provided directly to the outer periphery of the upper electrically insulating thin-film layer 4 and the lower electrically insulating thin-film layer 5 so that the electrically insulating plastic layer 7 is located outside.

The protective shielding layer 8 is formed such that one end edge 10 and the other end edge 11 thereof abut against each other in the cable-length direction without overlapping. This causes the protective shielding layer 8 to surround the periphery of the upper electrically insulating thin-film layer 4 and the lower electrically insulating thin-film layer 5 in a cable vertical cross-section. Specifically, the protective layer 8 abuts at the end edges 10 and 11 thereof without interruption in the cable-length direction in the vicinity of the upper left corner in the cable cross-sectional view, thereby forming an abutting part 12. The abutting part 12 is set apart from the signal conductor 1 as viewed in the cable-width direction, and is located above the ground conductor 2 disposed at the end part in the cable-width direction. The protective shielding layer 8 is preferably made to abut at the end edges thereof so that the abutting part 12 is formed as far from the signal conductor 1 as possible. It becomes more difficult to abut as the abutting part 12 approaches the end part in the cable-width direction. Therefore, taking the width of the ground conductor 2 in the cable-width direction as X, the abutting part 12 is formed above an area having a width of X/2 between an end part of the ground conductor 2 on the side opposite the signal conductor 1 and the central part in the cable-width direction of the ground conductor 2, as shown in FIG. 1. In FIG. 1, the abutting part 12 is located above the ground conductor 2 on the left side; however, the protective shielding layer 8 may be made to abut at the end edges thereof so that the abutting part 12 is located on the right side above the end part in the cable-width direction of the ground conductor 2′. Thus, the abutting part 12 is set apart from the signal conductor 1, allowing the effect on the signal conductor to be reduced and any reduction in the signal transmission characteristics in high-frequency bandwidths to be suppressed.

The protective shielding layer 8 with the metallic layer 6 and the electrically insulating plastic layer 7 integrally layered is set so as to cover the outer periphery of the upper electrically insulating thin-film layer 4 and the lower electrically insulating thin-film layer 5. In this state, hot-pressing is performed from above and below the protective shielding layer 8. This causes the upper electrically insulating thin-film layer 4 and the lower electrically insulating thin-film layer 5 to be softened and fused and then integrally bonded with the metallic layer 6, making it possible to prevent deformation of the protective shielding layer 8.

It is possible to prevent openings from appearing merely by making the end edges 10 and 11 of the protective layer 8 abut against each other without overlapping; therefore, the thickness of the upper electrically insulating thin-film layer 4 and the lower electrically insulating thin-film layer 5 can be kept constant along the entire cable width during hot-pressing. This makes it possible to suppress any reduction in the signal transmission characteristics in high-frequency bandwidths.

In the present embodiment, the end parts of the ground conductors 2, 2′ and the electrically insulating substrate 3, which are layered together, are bent about the end part of the lower electrically insulating thin-film layer 5 to form bent parts 9, 9′, and the bent parts of the ground conductors 2, 2′ are positioned on the side toward the metallic layer 6. Accordingly, the ground conductors 2, 2′ and the metallic layer 6 can be brought into electrical contact in a stable manner, and loss of signal transmission in high-frequency bandwidths in the signal transmission flat cable can be prevented from increasing. The bent parts 9, 9′ may be formed on the side toward the upper electrically insulating thin-film layer 4.

The signal conductor 1 and the ground conductors 2, 2′ are both formed using an excellent conductive metal. Specifically, the signal conductor 1 and the ground conductors 2, 2′ can be formed by processing copper (conductivity: 5.76×10⁷ S/m), which is typically used in industrial settings as an excellent conductive metal, into a foil shape and layering the copper foil on the electrically insulating thin-film layer 4 or the electrically insulating substrate 3, or by vapor-depositing or plating copper onto the electrically insulating thin-film layer 4 or the electrically insulating substrate 3. Examples of metals other than copper include aluminum (conductivity: 3.96×10⁷ S/m).

In electronic devices such as cellular telephones and notebook computers in which high-frequency signals exceeding 2 GHz are transmitted, electrical current is concentrated due to the “skin effect” on a surface layer measuring several microns. Forming a plating layer comprised of nickel or another material having lower conductivity than copper or aluminum would increase loss of transmission. Therefore, it is necessary to avoid forming such a plating layer on the surfaces of the signal conductor 1 and the ground conductors 2, 2′.

The metallic layer 6 forming the protective shielding layer 8 is preferably formed using an excellent conductive metal such as copper or aluminum, similarly to the signal conductor 1 and the ground conductors 2, 2′. In conventional signal transmission flat cables, a conductive adhesive layer is formed on the surface of the metallic layer 6 to bond the metallic layer 6 to the upper electrically insulating thin-film layer 4 and the lower electrically insulating thin-film layer 5. However, a conductive adhesive layer increases loss of transmission in electronic devices in which high-frequency signals such as those exceeding 2 GHz are transmitted. It is therefore necessary to avoid forming a conductive adhesive layer between the metallic layer 6 and the upper electrically insulating thin-film layer 4 and the lower electrically insulating thin-film layer 5.

In the present embodiment, the upper electrically insulating thin-film layer 4 is 0.125 mm thick, the electrically insulating substrate 3 is 0.025 mm thick, and the lower electrically insulating thin-film layer 5 is 0.100 mm thick. This allows the thicknesses of the insulators above and below the signal conductor 1 and the ground conductors 2, 2′ to be made equal (each being 0.125 mm), and it is possible to realize a signal transmission flat cable 100 that has the same signal transmission characteristics as a round coaxial cable having a characteristic impedance of 50Ω. A copper-clad laminate in which the 0.025-mm-thick electrically insulating substrate and the copper foil are layered is commercially available; using such a commercial product makes it possible to reduce the cost of the signal transmission flat cable.

The upper electrically insulating thin-film layer 4 and the lower electrically insulating thin-film layer 5 are made of a thermoplastic resin material that exhibits properties such as fusing and bonding when heated. The metallic layer 6 and the upper electrically insulating thin-film layer 4 and the lower electrically insulating thin-film layer 5 can thus be fused and bonded due to heat added from outside the protective shielding layer 8. This allows the protective shielding layer 8 and the upper electrically insulating thin-film layer 4 and the lower electrically insulating thin-film layer 5 to be not readily detached, making it possible to prevent deformation of the protective shielding layer 8. The metallic layer 6 and the upper electrically insulating thin-film layer 4 and the lower electrically insulating thin-film layer 5 are directly bonded without an adhesive that would cause increased loss of transmission, so that low-loss transmission is achievable.

The electrically insulating plastic layer 7 is made of a thermoplastic material that exhibits properties such as fusing and bonding when heated. Therefore, the protective shielding layer 8 is formed by direct layering the metallic layer 6 and the electrically insulating plastic layer 7 without an adhesive or the like. The metallic layer 6 is located inside and the electrically insulating plastic layer 7 is located outside to surround the upper electrically insulating thin-film layer 4 and the lower electrically insulating thin-film layer 5 as viewed in a cable vertical cross-section. That is, the protective shielding layer 8 is formed by layering the metallic layer 6 and the electrically insulating plastic layer 7 without an adhesive or the like, making it possible to form the protective shielding layer 8 more thinly and to realize a thin signal transmission flat cable.

The protective shielding layer 8 abut at one end edge 10 and the other end edge 11 thereof in the cable-length direction to form the abutting part 12. In this case, the metallic layer 6 and the electrically insulating plastic layer 7 are integrally bonded by fusion due to heating of the electrically insulating plastic layer 7. Therefore, no openings readily appear in or near the abutting part 12 at the end edges 10 and 11, making it possible to suppress any reduction in shielding effects.

The protective shielding layer 8 is set so as to cover the outer periphery of the upper electrically insulating thin-film layer 4 and the lower electrically insulating thin-film layer 5, and undergoes hot-pressing from above and below. In order to prevent or suppress changes in the shape of the electrically insulating plastic layer 7 caused by hot-pressing, it is preferable to use the same type of material in both the electrically insulating plastic layer 7 and the upper electrically insulating thin-film layer 4 and the lower electrically insulating thin-film layer 5, or to selectively use a material in the upper electrically insulating thin-film layer 4 and the lower electrically insulating thin-film layer 5 that soften at a lower temperature than does that used in the electrically insulating plastic layer 7.

The material used in the upper electrically insulating thin-film layer 4 and the lower electrically insulating thin-film layer 5 preferably exhibits properties such as fusing and bonding upon heated and has low permittivity and a low dielectric loss tangent in high-frequency bandwidths such as those exceeding 2 GHz. Examples of such a material include liquid crystal polymers and polytetrafluoroethylene.

The liquid crystal polymers are thermoplastic resins that show optical anisotropy during fusion. Specific examples include fully aromatic or semi-aromatic polyesters, polyester imides, and polyester amides, or resin compositions containing these substances. A liquid crystal polyester resin composition is preferred in which (A) a liquid crystal polyester is in a continuous phase and (B) a copolymer having a functional group that reacts with the liquid crystal polyester is in a dispersed phase.

It is necessary for the electrically insulating plastic layer 7 to exhibit properties such as fusing and bonding upon heated, as do the upper electrically insulating thin-film layer 4 and the lower electrically insulating thin-film layer 5, and to also exhibit properties of not changing shape or not readily changing shape due to heat added when the upper electrically insulating thin-film layer 4 and the lower electrically insulating thin-film layer 5 are bonded to the metallic layer 6 by heating. When the electrically insulating thin-film layer 4 is formed from a liquid crystal polymer, examples of the material for the electrically insulating plastic layer 7 include a liquid crystal polymer or plastic compositions containing a polyamide-imide resin soluble in polar organic solvents and a fluorine-based resin.

A coating formed merely from a polyamide-imide resin that is soluble in polar organic solvents has a permittivity of 3.5 or higher and a dielectric loss tangent of 0.012 or higher (permittivity and dielectric loss tangent both measured by cavity resonator perturbation at a frequency of 1 GHz); however, a coating (electrically insulating plastic layer 7) formed from a plastic composition containing a polyamide-imide resin soluble in polar organic solvents and a fluorine-based resin has a permittivity of 3.20 or less and a dielectric loss tangent of 0.01 or less (permittivity and dielectric loss tangent both measured by cavity resonator perturbation at a frequency of 1 GHz), significantly improving electrical characteristics.

The fluorine-based resin includes one or more substances selected from polytetrafluoroethylene, tetrafluoroethylene-perfluoroalkylvinylether copolymer, tetrafluoroethylene-hexafluoropropylene copolymer, tetrafluoroethylene-ethylene copolymer, and the like.

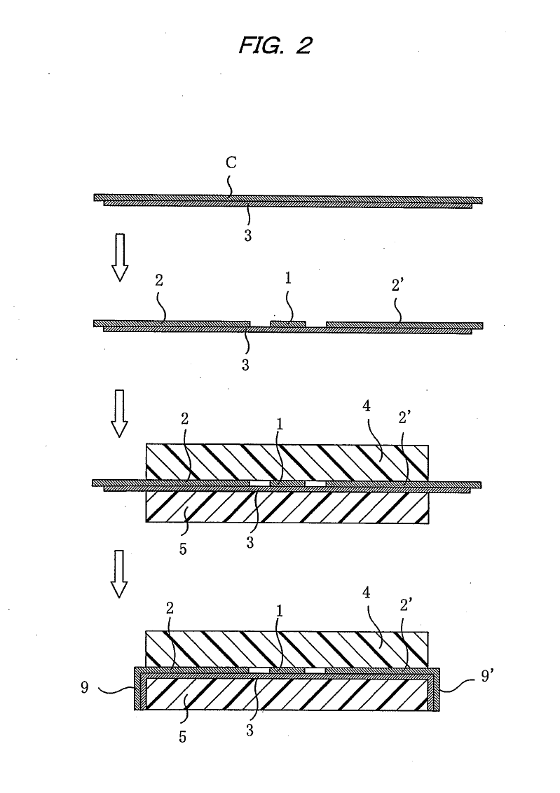

A method for manufacturing the signal transmission flat cable of the present embodiment will be described on the basis of FIG. 2. A copper-clad laminate is prepared by layering a copper foil C having a width equal to that of the electrically insulating substrate 3 on the upper surface thereof, and the signal conductor 1 and the ground conductors 2, 2′ are formed by etching the copper foil C (second figure from the top). This etching is performed such that the signal conductor 1 is positioned substantially at center in the cable-width direction.

Next, the upper electrically insulating thin-film layer 4 is layered on top of the signal conductor 1 and the ground conductors 2, 2′, and the lower electrically insulating thin-film layer 5 is provided below the electrically insulating substrate 3 (third figure from the top). Both the ends in the cable-width direction of the electrically insulating substrate 3 are then bent integrally with the ends in the cable-width direction of the ground conductor 2, 2′, thereby forming the bent parts 9, 9′ (bottommost figure).

Next, as shown in FIG. 1, the protective shielding layer 8 is formed on the outer periphery of the upper electrically insulating thin-film layer 4 and the lower electrically insulating thin-film layer 5. Hot-pressing is then performed from above and below the protective shielding layer 8. This causes the upper electrically insulating thin-film layer 4 and the lower electrically insulating thin-film layer 5 to be softened and fused and then bonded with the metallic layer 6 to produce the signal transmission flat cable 100.

In the signal transmission flat cable of the present embodiment, the electrically insulating substrate 3 fulfills the function of reinforcing the signal conductor 1 and the ground conductors 2, 2′ each comprised of a metallic thin film. The copper-clad laminate formed by layering the electrically insulating substrate 3 and the copper foil C is used to greatly improve the ease of handling the ground conductors 2, 2′, which are wider than the upper electrically insulating thin-film layer 4 and the lower electrically insulating thin-film layer 5. This facilitates the formation of the bent parts.

In the embodiment described above, both the ends in the cable-width direction of the electrically insulating substrate 3 are bent integrally with the ends in the cable-width direction of the ground conductors 2, 2′ toward the lower electrically insulating thin-film layer 5 to form the bent parts 9, 9′. However, the bent parts may instead be formed by bending toward the upper electrically insulating thin-film layer 4. In this case, the signal conductor 1 and the ground conductors 2, 2′ are provided above the electrically insulating substrate 3, and the ground conductors 2, 2′ are bent to come into contact with the metallic layer 6. Preferably, the thickness of the upper electrically insulating thin film 4 is made equal to that obtained by adding together the thickness of the electrically insulating substrate 3 and the thickness of the lower electrically insulating thin film 5 so that the thicknesses of the insulators above and below the signal conductor 1 and the ground conductors 2, 2′ are equal.

### Embodiment 2

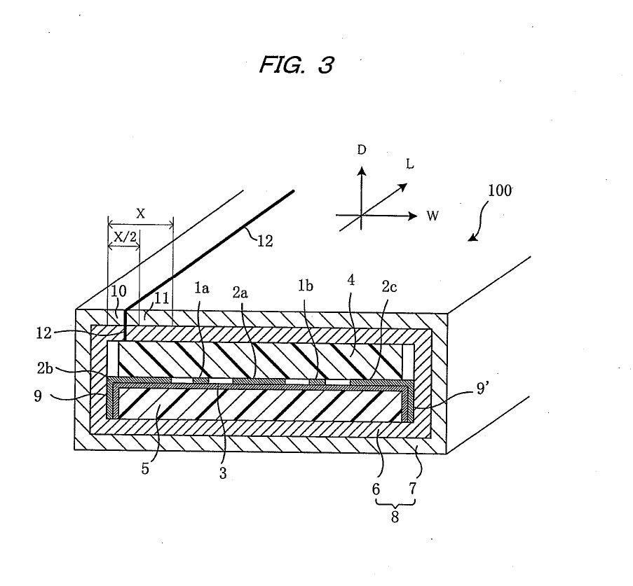

In the embodiment described above, one signal conductor is provided to form a single-core coaxial cable. FIG. 3 shows a flat cable 100 configured as a multi-core coaxial cable provided with a plurality of signal conductors. Members in FIG. 3 having the same reference symbols as in FIG. 1 are the same members. The shape, material, function, and the like of the members in FIG. 3 are as described in relation to FIG. 1; therefore, no detailed description will be given therefor.

In FIG. 3, two signal conductors 1a, 1b each comprised of a metallic thin film and three ground conductors 2a, 2b, 2c each comprised of a metallic thin film are arranged on a plane on one surface of an electrically insulating substrate 3. The signal conductors 1a, 1b are made of the same material as the signal conductor 1 in FIG. 1, and extend in parallel to one another in the cable-length direction L. Thus, two signal conductors are provided in the present embodiment. The ground conductors 2b, 2a are made of the same material as the ground conductors 2, 2′ in FIG. 1, and are arranged in parallel on the left and right sides in the cable-width direction of the signal conductor 1a, whereas the ground conductors 2a, 2c are arranged in parallel on the left and right sides in the cable-width direction of the signal conductor 1b. The ground conductor 2a is arranged between the signal conductors 1a, 1b, and the lengths of each of the ground conductors 2a, 2b, 2c in the cable-width direction are substantially equal.

In the present embodiment as well, the protective shielding layer 8 abuts at the end edge 10 and the end edge 11 thereof near the upper left corner in the cable cross-sectional view without interruption in the cable-length direction to form an abutting part 12. The abutting part 12 is located in a position set apart from the signal conductors 1a, 1b as viewed in the cable-width direction, and is positioned above the ground conductor 2b at the end part in the cable-width direction. The protective shielding layer 8 are preferably made to abut at the end edges thereof so that the abutting part 12 is formed as far from the signal conductors 1a, 1b as possible. It becomes more difficult to abut as the abutting part 12 approaches the end part in the cable-width direction. Therefore, taking the width of the ground conductor 2b in the cable-width direction as X, the abutting part 12 is, as shown in FIG. 3, formed above an area having a width of X/2 between an end part of the ground conductor 2b which is located at one end edge 10 of the protective shielding layer 8, the end part being on the side opposite the signal conductor 1a, and the central part in the cable-width direction of the ground conductor 2b. In FIG. 3, the abutting part 12 is located above the ground conductor 2b on the left side; however, the protective shielding layer 8 may be made to abut against each other so that the abutting part 12 is located above the end part in the cable-width direction of the ground conductor 2c on the right side. Thus, the abutting part 12 is set apart from the signal conductor 1a, 1b, thereby reducing the effect on the signal conductors and suppressing any reduction in the signal transmission characteristics in high-frequency bandwidths.

In the second embodiment as well, the end parts of the ground conductors 2b, 2c and the electrically insulating substrate 3, which are layered together, are bent about the end part of the lower electrically insulating thin-film layer 5 to thereby form bent parts 9, 9′ with the bent parts of the ground conductors 2b, 2c coming into contact with the metallic layer 6. Accordingly, the ground conductors 2b, 2c and the metallic layer 6 can be brought into electrical contact in a stable manner, and loss of signal transmission in high-frequency bandwidths in the signal transmission flat cable can be prevented from increasing. The bent parts 9, 9′ may be formed on the side toward the upper electrically insulating thin-film layer 4.

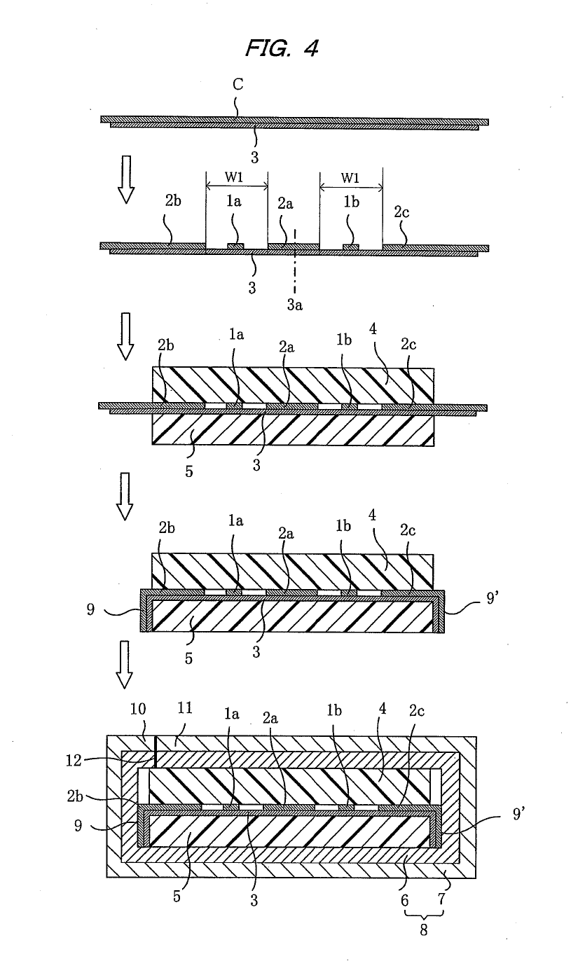

A method for manufacturing such a multi-core coaxial cable is shown in FIG. 4. A copper-clad laminate is prepared in which a copper foil C is layered on the upper surface of the electrically insulating substrate 3, the width of the copper foil C being made greater than that of the electrically insulating substrate 3 in consideration of the bent parts 9, 9′. The copper foil C is then etched, as shown in the second figure in FIG. 4, in order to form the signal conductors 1a, 1b and the ground conductors 2a, 2b, 2c. This etching is performed such that the center of the central ground conductor 2a coincides with the center 3a of the electrically insulating substrate 3, and such that the width between the ground conductors 2a and 2b and the width between the ground conductors 2a and 2c have the same value W1; the center of the signal conductor 1a is located centrally between the ground conductors 2a, 2b; and the center of the signal conductor 1b is located centrally between the ground conductors 2a, 2c.

Next, the upper electrically insulating thin-film layer 4 is layered on top of the signal conductors 1a, 1b and the ground conductors 2a, 2b, 2c, and the lower electrically insulating thin-film layer 5 is provided below the electrically insulating substrate 3 (third figure from the top). Both the ends in the cable-width direction of the electrically insulating substrate 3 are then bent integrally with the ends in the cable-width direction of the ground conductors 2b, 2c to form bent parts 9, 9′ (fourth figure from the top).

Next, the protective shielding layer 8 is formed on the outer periphery of the upper electrically insulating thin-film layer 4 and the lower electrically insulating thin-film layer 5, as shown in the bottommost figure, and hot-pressing is performed from above and below the protective shielding layer 8. This causes the upper electrically insulating thin-film layer 4 and the lower electrically insulating thin-film layer 5 to be softened and fused and then bonded with the metallic layer 6. Thus, a multi-core signal transmission flat cable 100 such as shown in FIG. 3 is produced.

In the present embodiment as well, the bent parts may be formed by bending toward the upper electrically insulating thin-film layer 4. In this case, the signal conductor 1a, 1b and the ground conductors 2a, 2b, 2c are provided above the electrically insulating substrate 3, and the ground conductors 2b, 2c are bent to come into contact with the metallic layer 6. Preferably, the thickness of the upper electrically insulating thin film 4 is made equal to that obtained by adding together the thickness of the electrically insulating substrate 3 and the thickness of the lower electrically insulating thin film 5 so that the thicknesses of the insulators above and below the signal conductor 1a, 1b and the ground conductors 2a, 2b, 2c are equal.

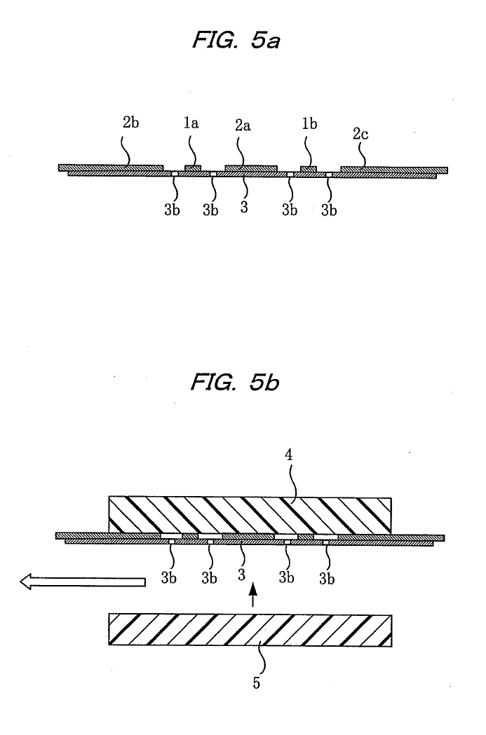

When the signal transmission flat cable is a multi-core coaxial cable, as in the present embodiment, multiple voids are formed between the signal conductors and the ground conductors. When air is present in these voids, permittivity increases. Accordingly, as shown in FIG. 5a, air-removal holes 3b are formed in the electrically insulating substrate 3 at positions that correspond to the positions of the voids between the signal conductor 1a and the ground conductors 2a, 2b as well as the positions of the voids between the signal conductor 1b and the ground conductors 2a, 2c. Then, as shown in FIG. 5b, the upper electrically insulating thin-film layer 4 is pressed to the signal conductors 1a, 1b and the ground conductors 2a, 2b, 2c to tightly seal the voids in order to remove air. Air is removed using a device (not shown) such that air in the voids is removed via the air-removal holes 3b. Once air has been removed, the lower electrically insulating thin-film layer 5 is pressed from below so as to come into close contact with the electrically insulating substrate 3 to maintain a state in which air has been removed from the voids. Afterward, the same steps as are shown in the fourth figure from the top and the bottommost figure of FIG. 4 are performed to produce a multi-core coaxial cable from which air has been removed.

The air-removal holes may be provided to a single-core coaxial cable. Specifically, air-removal holes may be formed in the electrically insulating substrate 3 at positions that correspond to the positions of the voids between the signal conductor 1 and the ground conductor 2, 2′.

In the embodiment described above, two signal conductors and three ground conductors were provided; however, a greater plurality of signal conductors and ground conductors may be provided. In such a case, the number of ground conductors provided is 1 greater than the number of signal conductors provided. For any number of conductors, the signal conductors and the ground conductors are arrayed so as to have line symmetry about the central line 3a of the electrically insulating substrate 3, and are arrayed such that the distances between adjacent ground conductors are all equal (W1 in FIG. 3) and the centers of the signal conductors between ground conductors are positioned centrally between the ground conductors. The conductors are also arrayed such that a ground conductor is positioned at each of the ends in the cable-width direction. When an even number of signal conductors is provided, a ground conductor is positioned at the center 3a of the electrically insulating substrate 3; when an odd number of signal conductors is provided, a signal conductor is positioned at the center 3a thereof. The one and the other end edges of the protective shielding layer 8 are made to abut against each other so that the abutting part 12 is positioned above any of the ground conductors.

### INDUSTRIAL APPLICABILITY

According to the present invention, it is possible to prevent deformation of a protective shielding layer caused by detachment between an electrically insulating thin-film layer and the protective shielding layer, and to suppress changes in the thickness of the upper electrically insulating thin-film layer 4 and the lower electrically insulating thin-film layer 5 in the cable-width direction. Therefore, any reduction in the signal transmission characteristics in high-frequency bandwidths can be suppressed.

### KEYS TO THE SYMBOLS

1 Signal conductor
1a, 1b Signal conductor
2, 2′ Ground conductor
2a, 2b, 2c Ground conductor
3 Electrically insulating substrate
3b Air-removal hole
4 Upper electrically insulating thin-film layer
5 Lower electrically insulating thin-film layer
6 Metallic layer
7 Electrically insulating plastic layer
8 Protective shielding layer
9 Bent part
12 Abutting part

1. A signal transmission flat cable comprising:
one or more signal conductors comprised of a metallic thin film that extend on a plane in parallel to one another in the cable-length direction;
a plurality of ground conductors comprised of a metallic thin film that are arranged on both sides in the cable-width direction of the signal conductors;
an electrically insulating substrate on which the signal conductors and the ground conductors are layered;
an upper electrically insulating thin-film layer and a lower electrically insulating thin-film layer that cover the signal conductors, the ground conductors, and the electrically insulating substrate from above and below in the cable-thickness direction; and
a protective shielding layer comprised of a metallic layer and an electrically insulating plastic layer to surround the outer periphery of the upper and lower electrically insulating thin-film layers such that the metallic layer is located inside and the electrically insulating plastic layer is located outside;
wherein the protective shielding layer surrounds the outer periphery with one end edge and the other end edge thereof abutting against each other along the cable-length direction, and the abutting part formed by abutting both the end edges of the protective shielding layer is located above the ground conductor.

2. A signal transmission flat cable according to claim 1, wherein the upper and lower electrically insulating thin-film layers are integrated with the metallic layer by bonding.

3. A signal transmission flat cable according to claim 1, wherein the abutting part is located above an area between an end part of the ground conductor which is located at the one end edge of the protective shielding layer, the end part being on the side opposite the signal conductor, and the central part in the cable-width direction of the ground conductor.

4. A signal transmission flat cable according to claim 1, wherein both ends in the cable-width direction of the electrically insulating substrate and the end parts of each of the ground conductors on the side opposite the signal conductors are integrally bent so that the ground conductors are brought into electrical contact with the metallic layer of the protective shielding layer.

5. A signal transmission flat cable according to claim 1, wherein the thickness of the upper electrically insulating thin-film layer is equal to that obtained by adding together the thickness of the electrically insulating substrate and the thickness of the lower electrically insulating thin-film layer.

6. A signal transmission flat cable according to claim 1, wherein air-removal holes for removing air in voids formed between the ground conductors and the signal conductors are formed in the electrically insulating substrate at positions that correspond to the positions of the voids.
